(19) United States
(12) Patent Application Publication
(10) Pub. No.: US 2025/0114674 A1
(43) Pub. Date: Apr. 10, 2025

(54) PICKLEBALL PADDLE

(71) Applicant: Bigwood Sporting Goods, LLC, Detroit, MI (US)

(72) Inventor: Forrest Solomon Hudes, Hamtramck, MI (US)

(73) Assignee: Bigwood Sporting Goods, LLC, Detroit, MI (US)

(21) Appl. No.: 18/905,636

(22) Filed: Oct. 3, 2024

Related U.S. Application Data
(60) Provisional application No. 63/542,556, filed on Oct. 5, 2023.

(51) Int. Cl. A63B 59/42; A63B 102/08; B32B 3/08; B32B 3/26; B32B 21/13

(52) U.S. Cl. CPC A63B 59/42; B32B 3/08; B32B 3/266; B32B 21/13; A63B 2102/08; A63B 2209/00; B32B 2250/40

(57) ABSTRACT

A sports paddle for playing paddle type games is provided. The sports paddle is crafted from sustainable wood materials and is formed in a plurality of layered substrate components comprising a first substrate layer and second substrate layer defining the exterior playing surfaces of the sports paddle, as well as a lightweight core structure that enhances playability and reduces strain during use. The core features hollow, recessed, or solid layers optimizing weight distribution and rigidity of the paddle, while optimizing and improving responsiveness, control, and energy return compared to traditional solid wooden paddles. The sports paddle is further structured with dual exterior playing surfaces and customizable handle configurations, ensuring compliance respective sport regulations while catering to both recreational and competitive players.

### CROSS REFERENCE TO RELATED APPLICATIONS

This application claims benefit of U.S. Provisional Application No. 63/542,556 filed on Oct. 5, 2023, and entitled HOLLOW CORE WOODEN PICKLEBALL PADDLE, which is hereby incorporated by reference in its entirety.

### TECHNICAL FIELD

The present disclosure generally relates to the field of racquet equipment and, more particularly, the design and construction of wooden pickleball paddles.

### BACKGROUND

Pickleball, a racquet sport invented in 1965, has experienced a dramatic surge in popularity in recent years, attaining the status of America's fastest-growing sport. Each player competes with a “paddle” as their primary piece of equipment, similar to tennis or other racquet sports. As the sport grows in popularity and competitiveness, players are continually seeking improvements in equipment to enhance their performance.

Early pickleball paddles were constructed from wood and cut into the shape of oversized ping-pong paddles. As competitive play has advanced in the sport, paddles made from lightweight materials such as plastics, composites, and metals have become increasingly popular. However, wooden pickleball paddles are still produced today, and fall into three main categories. The first category consists of inexpensive paddles manufactured from plywood sheets, similar to the early pickleball paddles, where the paddle shape is cut out of a solid sheet of plywood, and the handles have surface finishes applied. While such paddles are marketed to beginners due to their low cost, these plywood paddles can weigh up to 40 percent more than their modern competitive counterparts made from lightweight composites. The added weight of plywood paddles can hinder hand speed, a critical aspect of the game, and contribute to wrist and elbow fatigue and injury. Moreover, the solid, thinner paddle face of plywood paddles creates poor ball responsiveness, leading to less consistent and controllable shots. The second category of wooden pickleball paddles comprises of craft-made paddles constructed from solid wood. These paddles often command a higher price due to the aesthetic and material appeal of solid wood. However, they suffer from the same performance limitations as plywood paddles—heavier weight and reduced playability—making them a less viable option for serious competitors. Lastly, the third category consists of paddles that incorporate wooden surfaces. Such paddles typically utilize standard polycarbonate sheets for the interior of the paddle, with manufacturers applying wood veneer to the polycarbonate for decorative purposes, instead of carbon fiber or other synthetic materials. While this combination improves performance relative to solid wood paddles, these paddles are still largely composed of polymer material, and thus do not offer the sustainable qualities associated with genuine wooden paddles.

While the market for pickleball paddles has seen substantial innovation, most advancements have focused on composite paddles made from polymeric cores sandwiched between layers of synthetic materials due to the poor market perception of the performance characteristics of wooden paddles. These composite paddles dominate the competitive scene due to their lightweight construction and enhanced responsiveness. However, the widespread use of polymer and composite materials presents significant environmental concerns, as they are not biodegradable and contribute to the growing problem of polymer or plastic waste. Thus, despite the performance benefits of composite paddles, there is a growing need for more sustainable paddle designs that reduce reliance on single-use plastics while maintaining competitive playability.

As such, there is a need for innovative pickleball paddle designs that utilize sustainable materials, such as wood, while enhancing playability and offering a viable alternative to paddles made from plastic and composite materials. Furthermore, there is a need for a wooden pickleball paddle that is lightweight in design while offering improved maneuverability and player control.

### BRIEF SUMMARY OF THE INVENTION

The present disclosure is directed to exemplary paddles for use in various sports such as pickleball. According to one embodiment of the invention, the sports paddle may comprise a paddle body having a paddle face portion and a handle portion that extends from the paddle face portion, wherein the paddle body further comprises a plurality of layered substrate components, the plurality of layered substrate components comprising a first substrate defining a first exterior surface and first interior surface, a second substrate defining a second exterior surface and a second interior surface, wherein the first exterior surface and the second exterior surface are disposed as opposing exterior surfaces, and a core disposed between the first substrate and the second substrate, wherein the core further defines a plurality of voids and plurality of connective members arranged in a predetermined arrangement.

According to another embodiment of the invention, the sports paddle may comprise a paddle body having a paddle face portion and a handle portion that extends from the paddle face portion, wherein the paddle body further comprises a plurality of layered substrate components, the plurality of layered substrate components comprising a first substrate defining a first exterior surface and first interior surface, a second substrate defining a second exterior surface and a second interior surface, wherein the first exterior surface and the second exterior surface are disposed as opposing exterior surfaces, and a plurality of core layers disposed between the first substrate and the second substrate, wherein each of the plurality of core layers further comprises a first face and a second face opposite the first face, wherein the first face is a solid material face and the second face defines a plurality of recesses and a plurality of connective members arranged in a predetermined pattern.

### BRIEF DESCRIPTION OF THE DRAWINGS

The embodiments set forth in the drawings are illustrative and exemplary in nature and not intended to limit the subject matter. The following detailed description of the illustrative embodiments can be understood when read in conjunction with the following drawings, where like structure is indicated with like reference numerals and in which:

FIG. 1 is a partial cutaway view of one exemplary sports paddle in accordance with the present disclosure.

FIG. 2 is a side view of the exemplary sports paddle of FIG. 1.

FIG. 3A is a side view of a portion of an exemplary sports paddle in accordance with the present disclosure, in a first embodiment.

FIG. 3B is a side view of a portion of an exemplary sports paddle in accordance with the present disclosure, in a second embodiment.

FIG. 3C is a side view of a portion of an exemplary sports paddle in accordance with the present disclosure, in a third embodiment.

FIG. 4A is a side view of a portion of an exemplary sports paddle in accordance with the present disclosure, in a fourth embodiment.

FIG. 4B is a side view of a portion of an exemplary sports paddle in accordance with the present disclosure, in a fifth embodiment.

FIG. 5 is a front, plan view of an exemplary core layer of a sports paddle in accordance with the present disclosure.

FIG. 6 is an exploded perspective view of another exemplary sports paddle in accordance with the present disclosure.

FIG. 7 is a front, plan view of another exemplary core layer of a sports paddle in accordance with the present disclosure.

FIG. 8 is an exploded perspective view of another exemplary sports paddle in accordance with the present disclosure.

FIG. 9 is an exploded perspective view of another exemplary sports paddle in accordance with the present disclosure.

FIG. 10 is an exploded perspective view of another exemplary sports paddle in accordance with the present disclosure.

### DETAILED DESCRIPTION OF THE INVENTION

While the present disclosure may be described with respect to specific applications or industries, those skilled in the art will recognize the broader applicability of the disclosure.

Those having ordinary skill in the art will recognize the terms such as “a”, “an”, “the”, “at least one”, and “one or more” are used interchangeably to indicate that at least one of the items is present. A plurality of such items may be present unless the context clearly indicates otherwise. All numerical values of parameters (e.g., of quantities or conditions) in this specification, unless otherwise indicated expressly or clearly in view of the context, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. In addition, a disclosure of a range is to be understood as specifically disclosing all values and further divided ranges within the range.

The terms “comprising”, “including”, and “having” are inclusive and therefore specify the presence of stated features, steps, operations, elements, or components, but do not preclude the presence or addition of one or more other features, steps, operations, elements, or components. Orders of steps, processes, and operations may be altered when possible, and additional or alternative steps may be employed. As used in this specification, the term “or” includes any one and all combinations of the associated listed items. The term “any of” is understood to include any possible combination of referenced items, including “any one of” the referenced items. The term “any of” is understood to include any possible combination of referenced claims of the appended claims, including “any one of” the referenced claims.

Features shown in one figure may be combined with, substituted for, or modified by, features shown in any of the figures. Unless stated otherwise, no features, elements, or limitations are mutually exclusive of any other features, elements, or limitations. Furthermore, no features, elements, or limitations are absolutely required for operation. Any specific configurations shown in the figures are illustrative only and the specific configurations shown are not limiting of the claims or the description.

For consistency and convenience, directional adjectives are employed throughout this detailed description corresponding to the illustrated embodiments. Those having ordinary skill in the art will recognize that terms such as “above”, “below”, “upward”, “downward”, “top”, “bottom”, etc., may be used descriptively relative to the figures, without representing limitations on the scope of the invention, as defined by the claims. Any numerical designations, such as “first” or “second” are illustrative only and are not intended to limit the scope of the disclosure in any way.

The following discussion and accompanying figures disclose exemplary sports paddles. While the exemplary paddles are illustrated and described herein for use in the sport of pickleball, it will be understood that the exemplary paddles may be used for a variety of racquet sports such as, but not limited to, ping-pong, table tennis, platform tennis, paddle tennis, or the like.

In a general sense, the exemplary sports paddles 10, 100, 200, 300 of the present disclosure are constructed from sustainable materials, such as wood. More particularly, the exemplary sports paddles 10, 100, 200, 300 may incorporate a core 12, 22, 32, 42 including a plurality of voids 50a and/or recesses 60a such that the core 12, 22, 32, 42 reduces the overall weight of the paddle 10, 100, 200, 300, minimizing strain on the player's wrist and arm during use. In addition, the lightweight design enhances hand speed, making the sports paddles 10, 100, 200, 300 ideal for both recreational and competitive play. This design not only improves playability over traditional wooden paddles by enhancing responsiveness and control, but also offers an environmentally friendly alternative to modern paddles made from synthetic materials, without sacrificing performance.

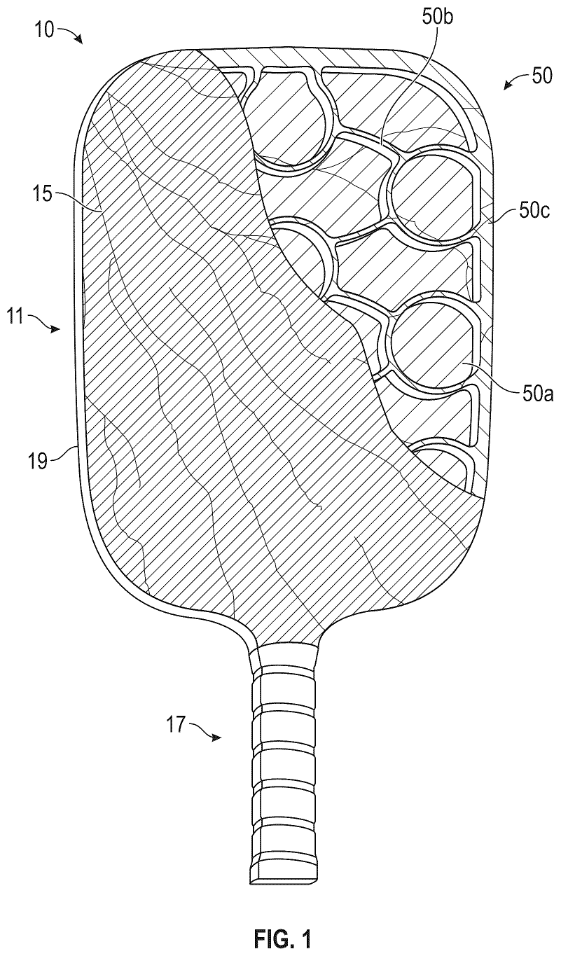

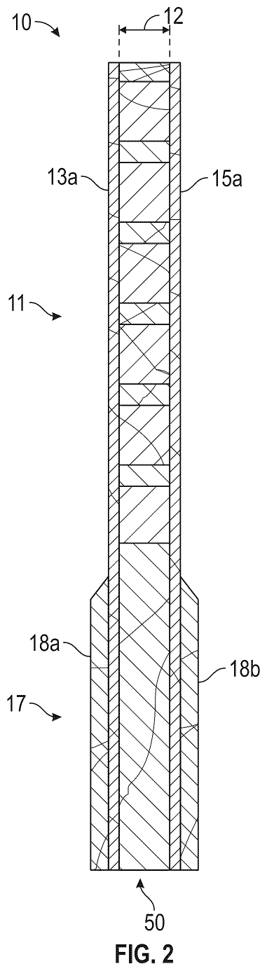

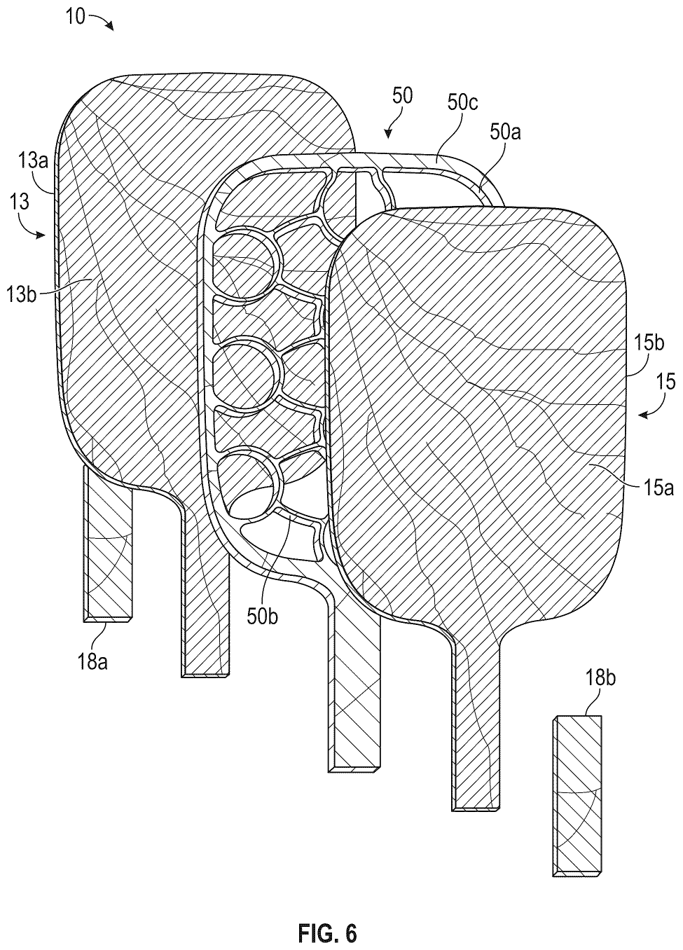

Referring now to the drawings, wherein like reference numerals refer to like components throughout the several views, exemplary sports paddles 10, 100, 200, 300 of the present disclosure are shown and described in FIGS. 1, 2, 6 and 8-10. Generally, the sports paddle 10, 100, 200, 300 may include a paddle body 11 having a paddle face portion 14 and handle portion 17. The paddle body 11 may further comprise a plurality of layered substrate components including two substrate layers, a first substrate layer 13 and a second substrate layer 15 defining exterior playing surfaces configured for striking an object such as a pickleball ball. In addition, the paddle body 11 of the sports paddle 10, 100, 200, 300 further comprises a core 12, 22, 32, 42 sandwiched between the two opposing substrate layers 13, 15.

The handle portion 17 may extend from the paddle face portion 14 and is configured to be gripped by the user during play. The handle portion 17 may further include two handle pallets, a first handle pallet 18a and a second handle pallet 18b, fixedly adhered thereto, for enhanced grip and/or comfort. As will be appreciated, the sports paddle 10, 100, 200, 300 may be manufactured in various sizes, shapes, and materials such that sports paddle 10, 100, 200, 300 is in accordance with USAPA regulations. In a preferred embodiment, the sports paddle 10, 100, 200, 300 is made of wood.

More specifically, the first substrate layer 13 may define a first exterior surface 13a and a first interior surface 13b. The second substrate layer 15 may define a second exterior surface 15a and a second interior surface 15b. Moreover, the first exterior surface 13a and the second exterior surface 15a are disposed as opposing exterior surfaces such that the surfaces are configured to be struck by an object such as a pickleball ball. Additionally, the first and second substrate layers 13, 15 may be fixedly adhered to the core 12, 22, 32, 42. More specifically, the core 12, 22, 32, 42 is fixedly adhered to the first substrate layer 13 at the first interior surface 13b and fixedly adhered to the second substrate layer 15 at the second interior surface 15b. It is contemplated that the adherence can be achieved through various methods known to those skilled in the art, such as through the use of one or more adhesives, lamination processes, mechanical fasteners, or heat-activated bonding processes. In a preferred embodiment, the first and second substrate layers 13, 15 are made of wood. The wood may be selected from various species based on desired characteristics such as weight, strength, and appearance. Moreover, the first and second substrate layers 13, 15 may be constructed from a plurality of layers of wood bonded or otherwise adhered together, such as, but not limited to, a veneer composed of two or more plies arranged at perpendicular grain angles to enhance strength, durability, and responsiveness. Alternatively, the first and second substrate layers 13, 15 may be made from solid pieces of wood. Moreover, it is contemplated that the first and second substrate layers 13, 15 do not continue through the entirety of the handle portion 17, such that the handle portion 17 is comprised of only the core 12, 22, 32, 42 and handle pallets 18a, 18b. Alternately, in some embodiments, the first and second substrate layers 13, 15 extend through the entirety of the handle portion 17, such that the handle portion 17 is comprised of the core 12, 22, 32, 42, the first and second substrate layers 13, 15, and the handle pallets 18a, 18b.

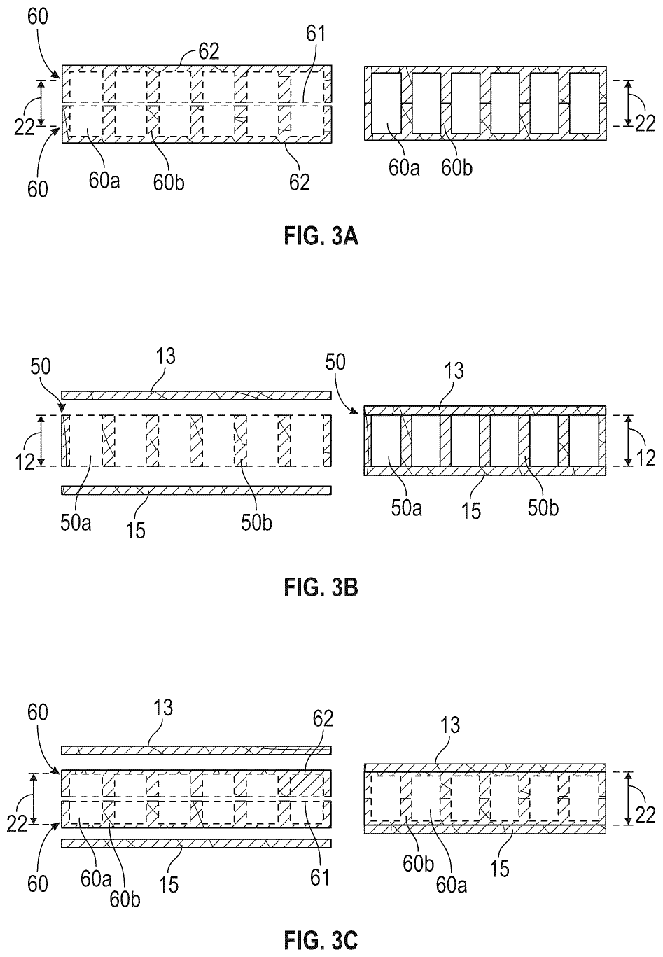

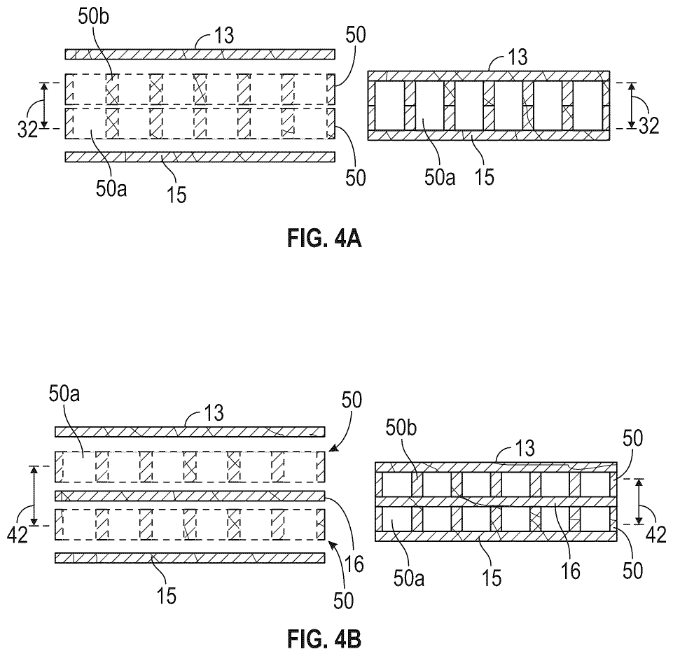

As described in more detail herein below with reference to FIGS. 3A-3C, and 4A-4B, the exemplary cores 12, 22, 32, 42 of the present disclosure may generally comprise a plurality of voids 50a and/or recesses 60a and a plurality of connective members 50b, 60b arranged in a predetermined pattern. Moreover, it is contemplated that the core comprises one or more core layers, such as a first core layer, a second core layer, etc. Preferably, the core 12, 22, 32, 42 is made of wood. The wood may be selected from various species based on desired characteristics such as weight, strength, and appearance. Moreover, core 12, 22, 32, 42 may be constructed from a plurality of layers of wood such as, but not limited to, a veneer composed of two or more plies arranged at perpendicular grain angles bonded or otherwise joined together by common methods known to those of ordinary skill in the art to enhance strength, durability, and responsiveness of the paddle. Alternatively, the core 12, 22, 32, 42 may be made from solid pieces of wood.

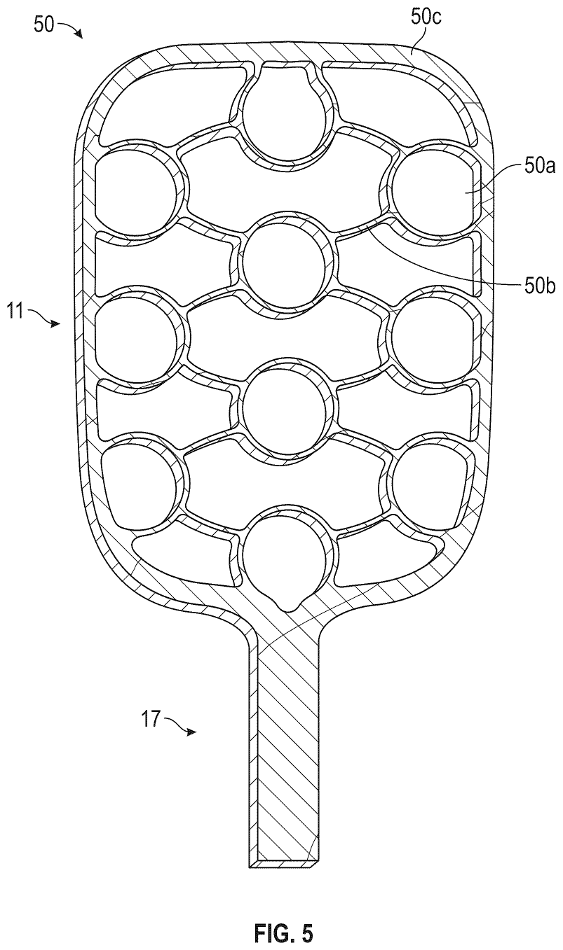

As shown in FIG. 5, an exemplary core layer 50, as shown in exemplary sports paddles 10, 200, 300, may comprise a plurality of voids 50a and connective members 50b arranged in a predetermined pattern throughout the paddle body 11. While the figures herein illustrate one exemplary pattern for the plurality of voids 50a and connective members 50b, e.g., a web-like or grid pattern, it will be understood that the voids 50a and connective members 50b may take on any pattern or design based on the desired performance characteristics of the paddle. The plurality of voids 50a and connective members 50b may function to enhance the playing characteristics of the finished paddle, provide strength and rigidity evenly across the paddle, and decrease the overall weight of the paddle. As shown in FIG. 5, the exemplary core layer 50 may be originally formed from a solid piece of material, preferably wood of a predetermined thickness and coplanarity. The voids 50a are created by removing material entirely from one side of the layer to the other. The voids 50a may be created by using various subtractive manufacturing techniques such as CNC milling, carving, gouging, routing, drilling, or other techniques known in the art to precisely remove material from the layer. The connective members 50b refer to the portions of the core layer that remain after material has been removed to create the voids 50a. Furthermore, the exterior edge 50c of the core layer 50 may be left solid, encasing the voids 50a and providing a surface around the perimeter of the core layer on which adhesives can be applied, to securely bond the core layer to another core layer, or to the first and second substrate layers 13, 15.

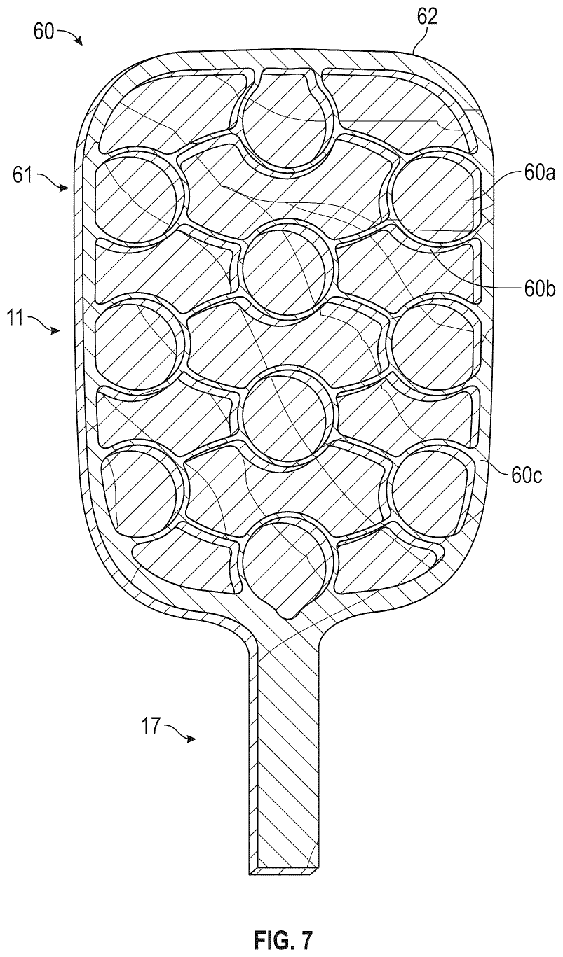

Turning now to FIG. 7, another exemplary core layer 60 is shown. Core layer 60 may comprise a plurality of recesses 60a and connective members 60b arranged in a predetermined pattern throughout the paddle body 11. While the figures herein illustrate one exemplary pattern for the plurality of recesses 60a and connective members 60b, it will be understood that the recesses 60a and connective members 60b may take on any pattern or design based on the desired performance characteristics of the paddle. The plurality of recesses 60a and connective members 60b may function to enhance the playing characteristics of the finished paddle, provide strength and rigidity evenly across the paddle, and decrease the overall weight of the paddle. As shown in FIG. 7, the core layer 60 may be originally formed from a solid piece of material, preferably wood of a predetermined thickness and coplanarity. The recesses 60a are created by removing material from the layer to a predetermined partial depth of material thickness such that the recesses do not pass completely through the layer 60, resulting in the layer 60 having a first face 62 being of solid material and a second face 61 with recesses 60a and connective members 60b arranged in a predetermined pattern throughout. The recesses 60a may be created by using various subtractive manufacturing techniques such as CNC milling, carving, gouging, routing, drilling, or other techniques known in the art to precisely remove material from the layer 60. The connective members 60b refer to the portions of the core layer 60 that remain after material has been removed to create the recesses 60a. Furthermore, the exterior edge 60c of the core layer 60 may be left solid, providing a surface around the perimeter of the core layer 60 on which adhesives can be applied, to securely bond the core layer 60 to another core layer or to the first and second substrate layers 13, 15.

More specifically, turning now to the exemplary core 12, 22, 32, 42 and sports paddle embodiments 10, 100, 200, 300 as shown in the figures, FIGS. 1, 2, 3B, and 6 illustrate a first exemplary paddle 10 and core 12 in accordance with the present disclosure. The core 12 of the exemplary paddle 10 comprises a single core layer 50 having a plurality of voids 50a and connective members 50b. The paddle 10 is constructed such that the core layer 50 is sandwiched between the first and second substrate layers 13, 15. More particularly, the core 12 is fixedly adhered to the first substrate layer 13 at the first interior surface 13b and fixedly adhered to the second substrate layer 15 at the second interior surface 15b via one of an adhesive, a lamination process, a plurality of mechanical fasteners, or a heat-activated bonding process. Further, exemplary paddle 10 may include an edge guard 19 which extends about a perimeter of the paddle body 11.

Exemplary paddle 10 also includes paddle body 11 having a paddle face portion 14 and handle portion 17, which extends from the paddle face portion 14 and is configured to be gripped by the user during play. The handle portion 17 may further include two handle pallets, a first handle pallet 18a fixedly adhered to the handle portion 17 of the first exterior surface 13a and a second handle pallet 18b fixedly adhered to the handle portion 17 of the second exterior surface 15a, for enhanced grip and/or comfort. In this embodiment, the handle portion 17 is a continuation of the singular core layer 50 and first and second substrate layers 13, 15, with handle pallets 18a, 18b attached to the respective handle portions.

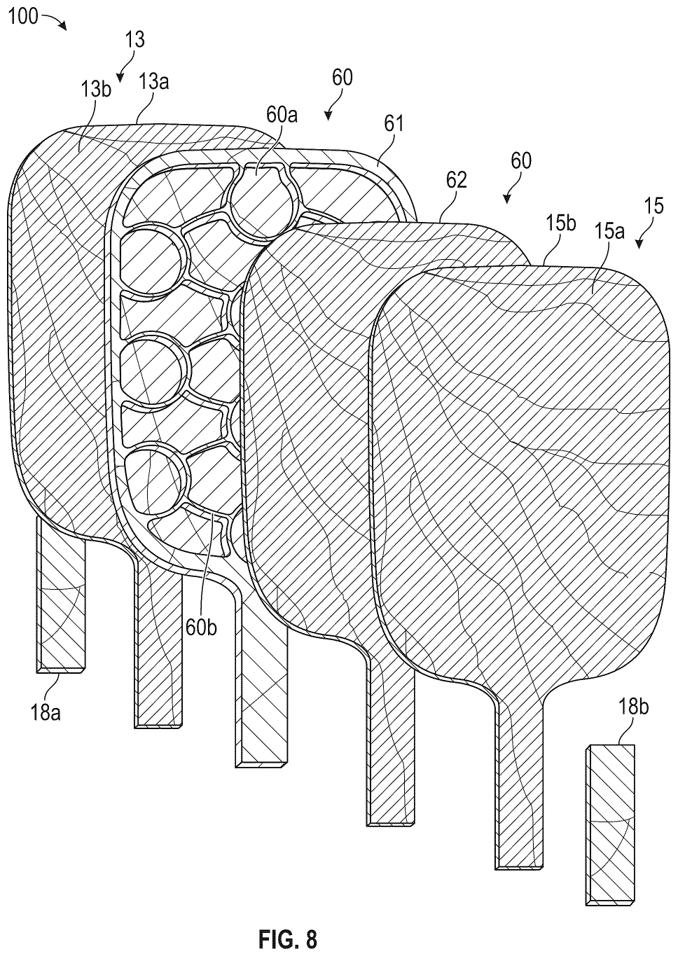

FIG. 3C and FIG. 8 illustrate a second exemplary sports paddle 100 comprising core 22 in accordance with the present disclosure. The core 22 of exemplary sports paddle 100 comprises two core layers 60 having a plurality of recesses 60a and connective members 60b arranged in a predetermined pattern throughout the paddle body 11. The core 22 is constructed by coupling the two core layers 60 to each other. Specifically, the second face 61 of each core layer 60, which includes recesses 60a and connective members 60b, faces inward during assembly while the first face 62, the solid material face, of each of the core layers 60 faces outward. The paddle 100 is constructed by sandwiching the core 22 between the first and second substrate layers 13, 15. More particularly, the core 22 is fixedly adhered to the first substrate layer 13 at the first interior surface 13b and fixedly adhered to the second substrate layer 15 at the second interior surface 15b via one of an adhesive, a lamination process, a plurality of mechanical fasteners, or a heat-activated bonding process.

Moreover, similar to first exemplary sports paddle 10, second exemplary sports paddle 100 includes paddle body 11 having a paddle face portion 14 and handle portion 17, which extends from the paddle face portion 14 and is configured to be gripped by the user during play. The handle portion 17 may further include two handle pallets, a first handle pallet 18a fixedly adhered to the handle portion 17 of the first exterior surface 13a and a second handle pallet 18b fixedly adhered to the handle portion 17 of the second exterior surface 15a, for enhanced grip and/or comfort. In this embodiment, the handle portion 17 is comprised of a continuation of the two core layers 60 and first and second substrate layers 13, 15, with handle pallets 18a, 18b attached to the respective handle portions.

FIG. 3A shows an alternate embodiment comprising two core layers 60. In this embodiment, the paddle does not include first and second substrate layers 13, 15 as in FIG. 3C. Instead, the first faces 62 of the core layers 60 serve as the outer playing surfaces configured to strike a ball. Said another way, when the two core layers 60 are coupled together, with the second faces 61 of each respective layer facing inward, the core 22 is created, and the first faces 62, the solid material faces, act as the striking surfaces.

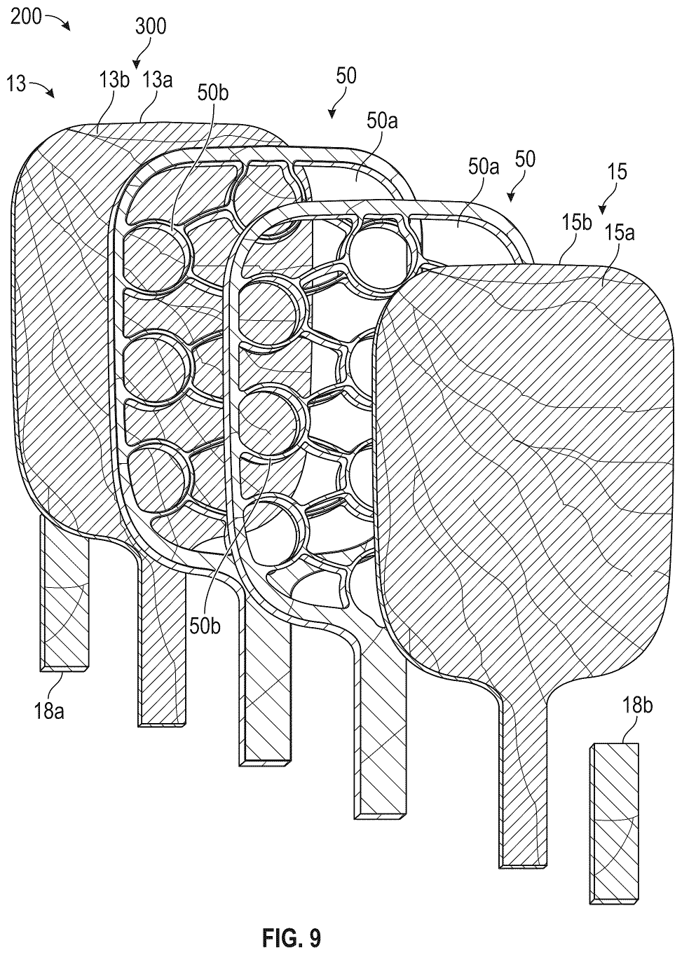

FIG. 4A and FIG. 9 illustrate a third exemplary sports paddle 200 comprising core 32 in accordance with the present disclosure. The core 32 of the exemplary paddle 200 comprises two core layers 50 having a plurality of voids 50a and connective members 50b arranged in a predetermined pattern throughout the paddle body 11. The core 32 is constructed by coupling the two core layers 50 to each other. The sports paddle 100 is constructed by sandwiching the core 32 between the first and second substrate layers 13, 15. More particularly, the core 32 is fixedly adhered to the first substrate layer 13 at the first interior surface 13b and fixedly adhered to the second substrate layer 15 at the second interior surface 15b via one of an adhesive, a lamination process, a plurality of mechanical fasteners, or a heat-activated bonding process.

Moreover, similar to first and second exemplary sports paddles 10, 100, the third exemplary sports paddle 200 includes paddle body 11 having a paddle face portion 14 and handle portion 17, which extends from the paddle face portion 14 and is configured to be gripped by the user during play. The handle portion 17 may further include two handle pallets, a first handle pallet 18a fixedly adhered to the handle portion 17 of the first exterior surface 13a and a second handle pallet 18b fixedly adhered to the handle portion 17 of the second exterior surface 15a, for enhanced grip and/or comfort. In this embodiment, the handle portion 17 is comprised of a continuation of the two core layers 50, and first and second substrate layers 13, 15, with handle pallets 18a, 18b attached to the respective handle portions.

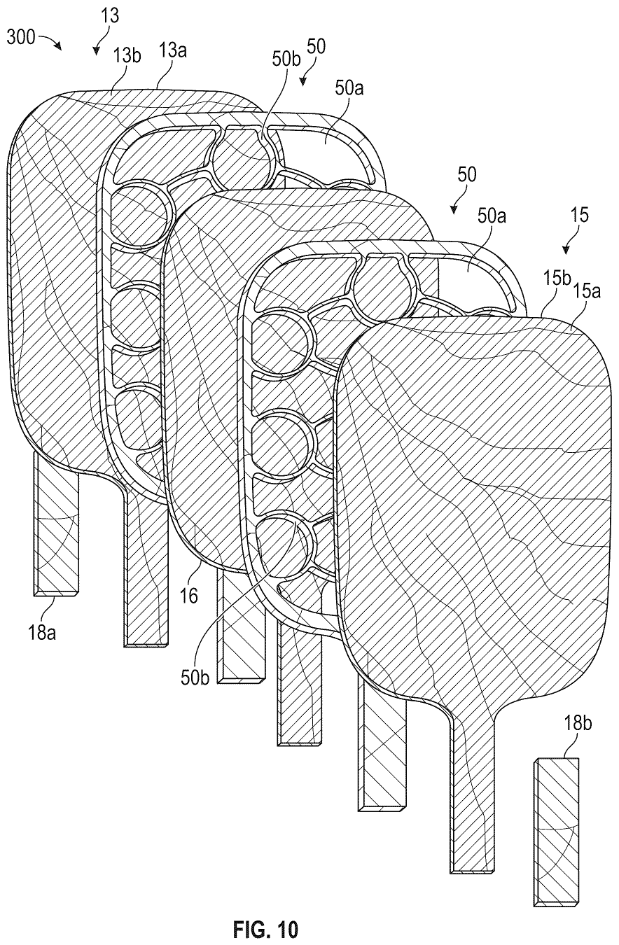

Lastly, FIG. 4B and FIG. 10 illustrate a fourth exemplary sports paddle 300 comprising core 42 in accordance with the present disclosure. The core 42 of the exemplary sports paddle 300 comprises two core layers 50 having a plurality of voids 50a and connective members 50b arranged in a predetermined pattern throughout the paddle body 11 and a third substrate 16. The core 42 is constructed by sandwiching the third substrate 16 between each of the core layers 50. The sports paddle 300 is constructed by sandwiching the core 42 between the first and second substrate layers 13, 15. More particularly, the core 42 is fixedly adhered to the first substrate layer 13 at the first interior surface 13b and fixedly adhered to the second substrate layer 15 at the second interior surface 15b via one of an adhesive, a lamination process, a plurality of mechanical fasteners, or a heat-activated bonding process.

Moreover, similar to first, second, and third exemplary sports paddles 10, 100, 200 the fourth exemplary sports paddle 300 includes paddle body 11 having a paddle face portion 14 and handle portion 17, which extends from the paddle face portion 14 and is configured to be gripped by the user during play. The handle portion 17 may further include two handle pallets, a first handle pallet 18a fixedly adhered to the handle portion 17 of the first exterior surface 13a and a second handle pallet 18b fixedly adhered to the handle portion 17 of the second exterior surface 15a, for enhanced grip and/or comfort. In this embodiment, the handle portion 17 is comprised of a continuation of the two core layers 50, the first, second, and third substrate layers 13, 15, 16, handle pallets 18a, 18b attached to the respective handle portions.

It is understood that the exemplary sports paddles 10, 100, 200, 300 of the present disclosure are merely illustrative. Other arrangements of the core 12, 22, 24, 34 may be employed in accordance with the disclosure and the claims set forth herein below. Moreover, it is contemplated that the voids 50a and/or recesses 60a may be filled with a predetermined amount of one or more types of filler material such as, but not limited to, lightweight foam, elastomers, or gel composites, to enhance the properties of the paddle or alter the sound production of the paddle when struck with an object such as a ball. Further, it is contemplated that the sports paddles 10, 100, 200, 300, including the first, second, and third substrate layers 13, 15, 16, and the one or more core layers 50, 60, may utilize materials other than wood, such as, but not limited to, composites, fiberglass, carbon fiber, recycled plastics, and the like, or a combination thereof. Moreover, it is contemplated that additional materials may be added to the paddle such as, but not limited to, handle grips, over grips, wood finishes, sealants, tapes, protective layers, covers, guards, stickers, graphics, and the like.

In the manner described above, the exemplary sports paddles 10, 100, 200, 300 of the present teachings utilize sustainable materials, such as wood, to yield high-performance paddles. Furthermore, the exemplary sports paddles 10, 100, 200, 300 of the present teachings comprise cores 12, 22, 32, 42 having a plurality of voids and/or recesses arranged in a predetermined pattern to maintain a competitive low weight and create a responsive playing surface.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

While various embodiments have been described, the description is intended to be exemplary, rather than limiting, and it will be apparent to those of ordinary skill in the art that many more embodiments and implementations are possible that are within the scope of the embodiments. Any feature of any embodiment may be used in combination with or substituted for any other feature or element in any other embodiment unless specifically restricted. Accordingly, the embodiments are not to be restricted except in light of the attached claims and their equivalents. Also, various modifications and changes may be made within the scope of the attached claims.

Benefits, other advantages, and solutions to problems, and any element or elements that may cause any benefit, advantage, or solution to occur or become more pronounced, however, are not to be construed as critical, required, or essential features or elements of any or all of the claims, unless such benefits, advantages, solutions, or elements are expressly stated in such claims.

### LISTING OF REFERENCE NUMERALS

10, 100, 200, 300 Sports Paddle
11 Paddle Body
12, 22, 32, 42 Core
13 First Substrate Layer
13a First Exterior Surface (of First Substrate Layer)
13b First Interior Surface (of First Substrate Layer)
14 Paddle Face Portion
15 Second Substrate Layer
15a Second Exterior Surface (of Second Substrate Layer)
15b Second Interior Surface (of Second Substrate Layer)
16 Third Substrate Layer
17 Handle Portion
18a First Handle Pallet
18b Second Handle Pallet
19 Edge Guard
50 Core Layer
50a Plurality of Voids
50b Plurality of Connective Members
50c Exterior Edge of Core Layer 50
60 Core Layer
60a Plurality of Recesses
60b Plurality of Connective Members
60c Exterior Edge of Core Layer 60
61 Second Face
62 First Face

What is claimed is:

1. A sports paddle comprising:
a paddle body having a paddle face portion and a handle portion that extends from the paddle face portion, wherein the paddle body further comprises a plurality of layered substrate components, the plurality of layered substrate components comprising:
a first substrate defining a first exterior surface and first interior surface;
a second substrate defining a second exterior surface and a second interior surface, wherein the first exterior surface and the second exterior surface are disposed as opposing exterior surfaces; and
a core disposed between the first substrate and the second substrate, wherein the core further defines a plurality of voids and plurality of connective members arranged in a predetermined arrangement.

2. The sports paddle of claim 1 wherein each of the first substrate, the second substrate, and the core are composed of wood.

3. The sports paddle of claim 2 wherein the paddle face portion and handle portion of each of the first substrate, second substrate, and core are integrally formed as a single unitary piece.

4. The sports paddle of claim 3 wherein the core further comprises a unitary exterior edge extending about a perimeter of the core, such that the unitary exterior edge is disposed about and contains the predetermined arrangement of voids and connective members.

5. The sports paddle of claim 4 wherein the core is fixedly adhered to the first substrate at the first interior surface and fixedly adhered to the second substrate at the second interior surface via one of an adhesive, a lamination process, a plurality of mechanical fasteners, or a heat-activated bonding process.

6. The sports paddle of claim 5 wherein:
the paddle face portion of the first exterior surface is an exterior playing surface;
the paddle face portion of the second exterior surface is another exterior playing surface; and
the sports paddle further comprises a first handle pallet fixedly adhered to the handle portion of the first exterior surface and a second handle pallet fixedly adhered to the handle portion of the second exterior surface.

7. The sports paddle of claim 5 wherein the core comprises a first core layer and a second core layer.

8. The sports paddle of claim 7 wherein the first core layer comprises the plurality of voids and the plurality of connection members in a first predetermined arrangement; and wherein the second core layer comprises the plurality of voids and the plurality of connection members in a second predetermined arrangement.

9. The sports paddle of claim 8 wherein the first predetermined arrangement and the second predetermined arrangement are identical.

10. The sports paddle of claim 8 wherein the first core layer is fixedly adhered to the second core layer via an adhesive, a lamination process, a plurality of mechanical fasteners, or a heat-activated bonding process.

11. The sports paddle of claim 7 wherein the paddle body further comprises a third substrate layer disposed between the first core layer and the second core layer.

12. The sports paddle of claim 11 wherein the third substrate layer is fixedly adhered to each of the first core layer and the second core layer via an adhesive, a lamination process, a plurality of mechanical fasteners, or a heat-activated bonding process.

13. A sports paddle comprising:
a paddle body having a paddle face portion and a handle portion that extends from the paddle face portion, wherein the paddle body further comprises a plurality of layered substrate components, the plurality of layered substrate components comprising:
a first substrate defining a first exterior surface and first interior surface;
a second substrate defining a second exterior surface and a second interior surface, wherein the first exterior surface and the second exterior surface are disposed as opposing exterior surfaces; and
a plurality of core layers disposed between the first substrate and the second substrate, wherein each of the plurality of core layers further comprises a first face and a second face opposite the first face, wherein the first face is a solid material face and the second face defines a plurality of recesses and a plurality of connective members arranged in a predetermined pattern.

14. The sports paddle of claim 13 wherein each of the first substrate, the second substrate, and the core are composed of wood.

15. The sports paddle of claim 14 wherein the paddle face portion and handle portion of each of the first substrate, second substrate, and each of the plurality of core layers are integrally formed as a single unitary piece.

16. The sports paddle of claim 15 wherein:
the paddle face portion of the first exterior surface is an exterior playing surface;
the paddle face portion of the second exterior surface is another exterior playing surface; and
the sports paddle further comprises a first handle pallet fixedly adhered to the handle portion of the first exterior surface and a second handle pallet fixedly adhered to the handle portion of the second exterior surface.

17. The sports paddle of claim 15 wherein each connective member has a top and each recess has a predetermined depth, wherein the predetermined depth of each recess extends from the first face to the top of the respective connective member.

18. The paddle of claim 17 wherein the plurality of core layers further comprises a first core layer and a second core layer, wherein:
the first core layer is disposed between the first substrate layer and the second core layer, such that the first face is disposed in contact with the first substrate layer and the second face is disposed in contact with the second core layer; and
the second core layer is disposed between the first core layer and the second substrate layer, such that the first face is disposed in contact with the second substrate layer and the second face is disposed in contact with the first core layer.

19. The paddle of claim 18 wherein:
the first face of the first core layer is fixedly adhered to the first interior surface of the first substrate layer and the second face of the first core layer is fixedly adhered to the first face of the second core layer via one of an adhesive, a lamination process, a plurality of mechanical fasteners, or a heat-activated bonding process; and
the second face of the second core layer is fixedly adhered to the second face of the first core layer and the first face of the second core layer is fixedly adhered to the second interior surface of the second substrate layer via one of an adhesive, a lamination process, a plurality of mechanical fasteners, or a heat-activated bonding process.

20. The sports paddle of claim 19 wherein:
the first core layer comprises the plurality of recesses and the plurality of connection members in a first predetermined arrangement;
the second core layer comprises the plurality of voids and the plurality of connection members in a second predetermined arrangement; and
the first predetermined arrangement and the second predetermined arrangement are identical.
